(19) United States
(12) Patent Application Publication
(10) Pub. No.: US 2004/0136683 A1
(43) Pub. Date: Jul. 15, 2004

(54) AGC circuit

(75) Inventor: Hidekazu Inoue, Oura-Gun (JP)

Correspondence Address: HOGAN & HARTSON L.L.P., Biltmore Tower, Ste. 1900, 500 S. Grand Ave., Los Angeles, CA, 90071, US

(73) Assignee: SANYO ELECTRIC CO., LTD.

(21) Appl. No.: 10/744,628

(22) Filed: Dec. 23, 2003

(30) Foreign Application Priority Data
Dec. 27, 2002 (JP) 2002-381438

(51) Int. Cl. H04N 5/76

(52) U.S. Cl. 386/9; 386/46

(57) ABSTRACT

The level of a playback signal is detected by an AGC detector circuit and a current relating to the detected playback signal is supplied to a switching circuit. Furthermore, a constant current generated at a constant-current generator circuit is also supplied to the switching circuit. In accordance with the detection result of a no-signal detector circuit, the switching circuit outputs a constant signal when there is no signal and a current for the playback signal level when there is a signal. A current-voltage converter circuit converts the current from the switching circuit into a control voltage, which is supplied to the AGC amplifier as a gain control signal. As a result, the control voltage in the AGC amplifier can be set to a constant for when there is no signal so that the gain setting can be improved.

### BACKGROUND OF THE INVENTION

1. Field of the Invention

The present invention relates to an AGC circuit for controlling the gain of an amplifier for audio signals or the like.

2. Description of the Related Art

An AGC circuit for amplifying an input signal into a signal having a predetermined level was used in the prior art. In the AGC circuit, the level of the input signal is detected and the gain of the amplifier is controlled in accordance with the detected result.

For example, an AGC circuit is also used in the amplification process for audio playback signals in the playback of digital video tapes. This enables the playback signal to be amplified to a signal having a predetermined level.

In the convention AGC circuit, the AGC circuit operates also during periods of silence, and during these periods of silence (no signal), the gain of the AGC circuit is set to a maximum value. Namely, in the transitions from no signal→signal period→no signal period as shown in FIG. 9(a), the signal includes noise components even during the no signal period.

On the other hand, as shown in FIG. 9(b), the detection voltage that detects the level of the signal is a low voltage when there is no signal and a high voltage when there is a signal, with a slight delay occurring at the changes. Thus, a delay develops in the AGC operation that is performed in accordance with the detection voltage.

Therefore, as shown in FIG. 9(c), the detection voltage indicating the level of the playback signal drops when there is no signal, and since the AGC amplifier is at full gain, noise is amplified. Furthermore, at the beginning of the signal period until the period where the gain reaches an appropriate value, the amplification is performed at full gain resulting in a problem where the output level is larger than necessary.

### SUMMARY OF THE INVENTION

The present invention controls the gain of an AGC amplifier with a fixed level signal when there is no signal. The gain of the AGC amplifier for when there is no signal can be set to an appropriate value so that the high amplification of noise can be prevented. Furthermore, since the control signal is set to an appropriate level for when there is no sound, the AGC tracking characteristic can be improved at the transition from a no-signal state to a signal present state.

### BRIEF DESCRIPTION OF THE DRAWINGS

FIG. 1 is a block diagram showing an overall configuration of an embodiment.

FIG. 2 shows a state when a playback signal is switched.

FIG. 3 shows a transition from a no-signal period to a signal period.

FIG. 4 is an enlarged view of the signal period in the transition from the no-signal period to the signal period shown in FIG. 3.

FIG. 5 shows a specific configuration for the no-signal detector circuit.

FIG. 6 shows the voltage waveforms at the respective points in FIG. 5.

FIG. 7 shows a specific configuration for the AGC detector circuit 10 and the no-signal detector circuit 12.

FIG. 8 shows the constant-current generator circuit 16, switching circuit 14, current-voltage converter circuit 18, and AGC amplifier AP1.

FIG. 9 shows the configuration of a conventional AGC circuit.

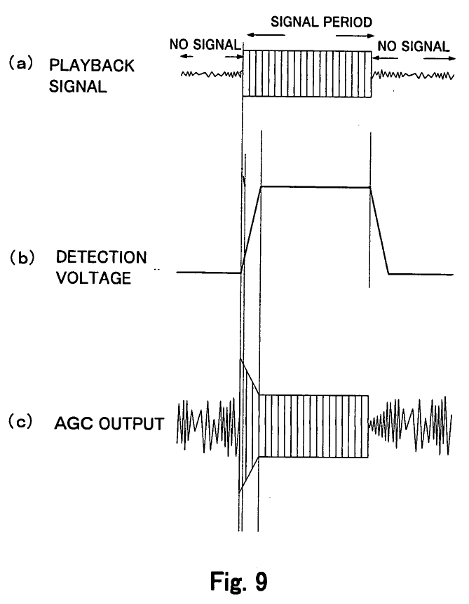

### DETAILED DESCRIPTION OF THE PREFERRED EMBODIMENTS

The embodiment of the present invention will be described hereinafter with reference to the drawings.

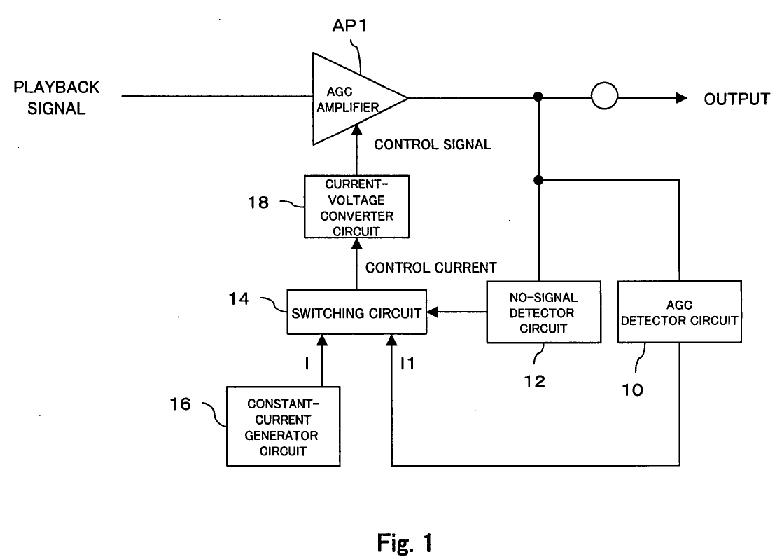

FIG. 1 is a block diagram showing an overall configuration of the embodiment. A playback signal captured by a head is amplified at a predetermined gain, such as by a playback amplifier, and then input by an AGC amplifier AP1. The AGC amplifier AP1 is a gain-adjustable amplifier for which the gain is set on the basis of a control signal. The output of the AGC amplifier AP1 is output as the playback signal to a post-processor.

Furthermore, the output of the AGC amplifier AP1 is supplied to an AGC detector circuit 10. The AGC detector circuit 10 compares the level of the output signal of the AGC amplifier AP1 with a reference voltage that has been set beforehand, and outputs an AGC current I1 that corresponds to the difference between the two signals. Furthermore, the output of the AGC amplifier AP1 is also supplied to a no-signal detector circuit 12. The no-signal detector circuit 12 judges whether or not the input signal is at a low level, at which the absence of a signal is assumed, and outputs a switching signal that indicates whether or not the input signal is at a no-signal state in accordance with the judgment result.

The AGC current I1 from the AGC current detector circuit 10 is supplied to a switching circuit 14. To the switching circuit 14 is also supplied a constant current I from a constant-current generator circuit 16. Then, according to the switching signal from the no-signal detector circuit 12, the switching circuit 14 selects and outputs either one of the AGC current I1 or the constant current I as a control current. Namely, if the switching signal indicates the absence of a signal, the constant current I is selected, and if the switching signal indicates the presence of a signal, the AGC current I1 is selected.

The output of the switching circuit 14 is supplied to a current-voltage converter circuit 18 where it undergoes current to voltage conversion, and the obtained control voltage is supplied as a gain control signal to the AGC amplifier AP1.

In this manner, according to the present embodiment, gain control of the AGC amplifier AP1 is performed during the presence of a signal on the basis of the playback signal level that is generated from the AGC detector circuit 10 so that the level of the output signal can be maintained at a predetermined level. On the other hand, during the absence of a signal, the control signal is a predetermined fixed value so that the gain of the AGC amplifier AP1 is kept at a fixed value.

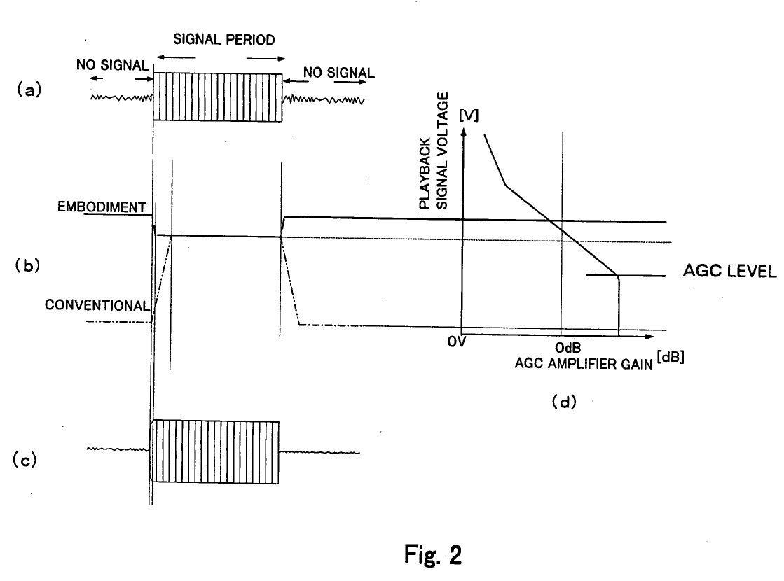

FIG. 2 shows a state when the playback signal is switched in this manner: no signal→signal→no signal. Namely, the state of the level changes in the playback signal is shown in (a) of FIG. 2. (b) of FIG. 2 shows the control voltage (detection voltage), which is the output of the current-voltage converter circuit 18. In this manner, during the absence of a signal, it is a relatively high detection voltage in accordance with the current I of the constant-current generator circuit 16. Then, at the change from a no-signal state to a signal present state, the width of the change in detection voltage is narrow and the detection voltage changes smoothly. Therefore, as shown in (c) of FIG. 2, at the beginning of the signal period, there is no large change in level. Furthermore, when there is no signal, the gain of the AGC gain AP1 is kept relatively small so that any noise during the absence of a signal can be suppressed to a small value.

Namely, as shown in (d) of FIG. 2, according to the detection voltage that is based on the constant current I for when there is no signal, the gain of the AGC amplifier AP1 is suppressed to a level slightly lower than 0 dB. As a result, the gain during the absence of a signal can be prevented from increasing and the tracking characteristic can also be improved when a no-signal state is switched to a signal present state.

The playback signal in the input and output of the AGC amplifier AP1 has a transient period between the no-signal state and the signal present state. When this transient period is relatively long, the detection voltage (control voltage) that was maintained during the no-signal period initially drops. Namely, although the control voltage is maintained at a predetermined value by the constant current I in the period judged as having no signal, the maintained control voltage initially drops when the transient period is long so that at the beginning where the signal enters a stable period as in the prior art, the gain of the AGC amplifier AP1 may be too high.

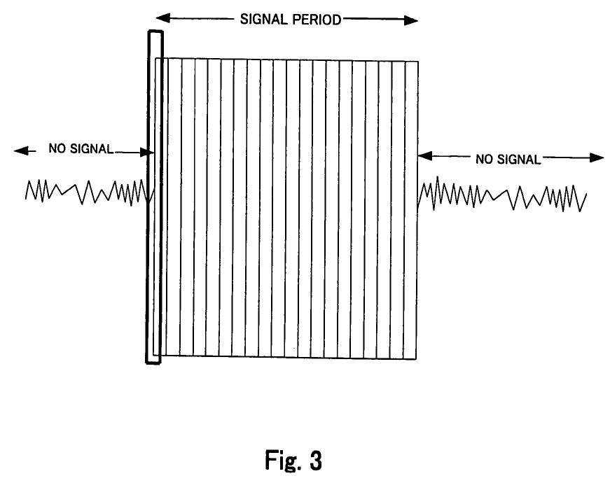

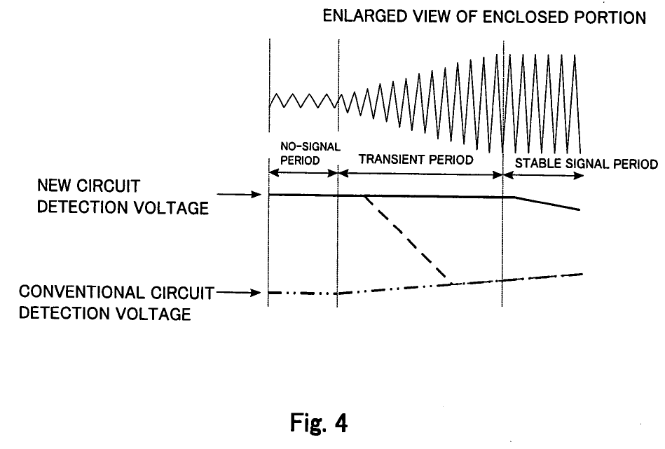

For example, the beginning of the signal period at the transition from the no-signal period to the signal period shown in FIG. 3 is enlarged in FIG. 4. In this manner, as shown by the dashed line in the figure, the detection voltage of the present embodiment in the transient period initially decreases to the level of the prior art (long dashed double-dotted line), and rises thereafter.

The present embodiment includes a delay circuit in the no-signal detector circuit 12. After the elapse of a predetermined time once it is judged a signal is present, the switching signal is supplied to the switching circuit 14. Therefore, as shown by the continuous line in FIG. 4, the detection voltage is prevented from decreasing in the transient period and an appropriate gain setting is performed from the beginning of the signal period.

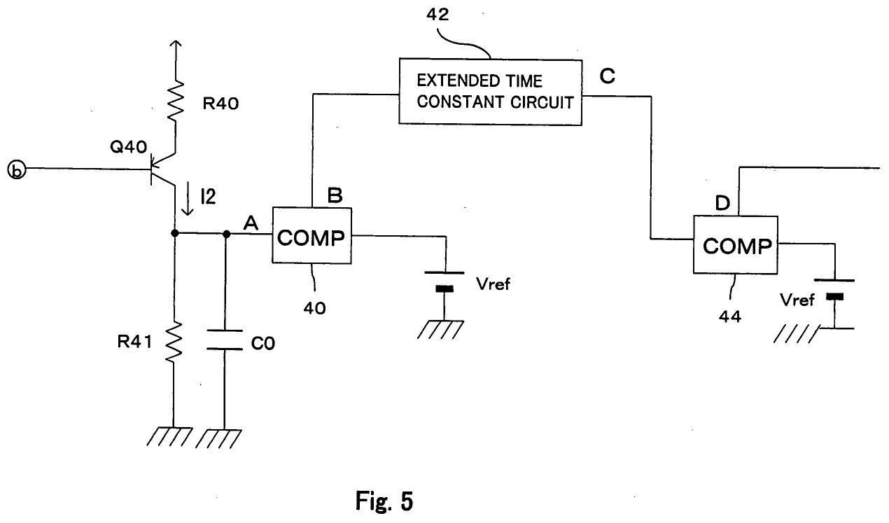

A specific circuit for this purpose is shown in FIG. 5. First, a signal indicating the playback signal level that is obtained by detecting the level of the playback signal is supplied to the base of a PNP transistor Q40. The transistor Q40 has an emitter connected to a voltage supply V_{cc} through a resistor R40 and a collector connected to ground through a resistor R41. Furthermore, a capacitor CO is connected in parallel to the resistor R41. Therefore, a current I2 relating to the playback level flows and a voltage corresponding to the top of the resistor R41 and the capacitor C0 is obtained at the transistor Q40. The voltage at the top of the resistor R41 is input by a comparator 40. A predetermined reference voltage V_{ref} is supplied to the comparator 40. The comparator 40 compares the input voltage and the reference voltage V_{ref}, and outputs a signal that is high (H) when the input voltage exceeds the reference voltage.

The output of the comparator 40 is supplied to an extended time constant circuit 42. The extended time constant circuit 42 comprises a low-pass filter (RC integrating circuit) having a predetermined time constant and outputs the change in the output of the comparator 40 after a delay of a predetermined time. The output of the extended time constant circuit 42 is further supplied to a comparator 44, where it is compared with the reference voltage V_{ref}, and a signal of the comparison result is output.

If the level of the input playback signal is, for example, 70 mVpp (upper threshold of a level judged as having no sound) or higher, the comparator 40 has an output of H. The extended time constant circuit 42, after the elapse of a predetermined delay time (such as 5 μs), delays the change in the output at the time constant so that the output of the comparator 44 changes to H. Therefore, after the output of the comparator 40 changes and until the output of the comparator 44 changes, a delay having a predetermined set time (such as 5 μs or so) is set.

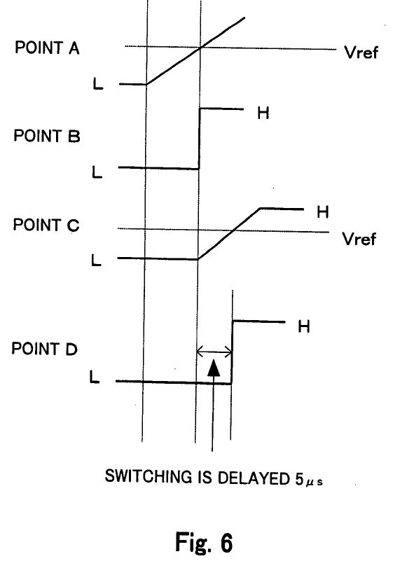

FIG. 6 shows the voltages at four points: input (point A) of the comparator 40, output (point B) of comparator 40, output (point C) of the extended time constant circuit 42, and output (point D) of the comparator 44. In this manner, when the voltage at point A rises linearly, the voltage at point B instantaneously changes from L (low) to H at a point where the voltage at point A exceeds the reference voltage V_{ref}. On the other hand, at point C, the change becomes gradual and the voltage changes from L to H at a predetermined slope. At point D, the voltage rises from L to H at a predetermined delay time (such as 5 μs).

A switching operation is performed at the switching circuit 14 using the signal at point D so that the detection voltage (control voltage) shown by the continuous line in FIG. 4 can be obtained.

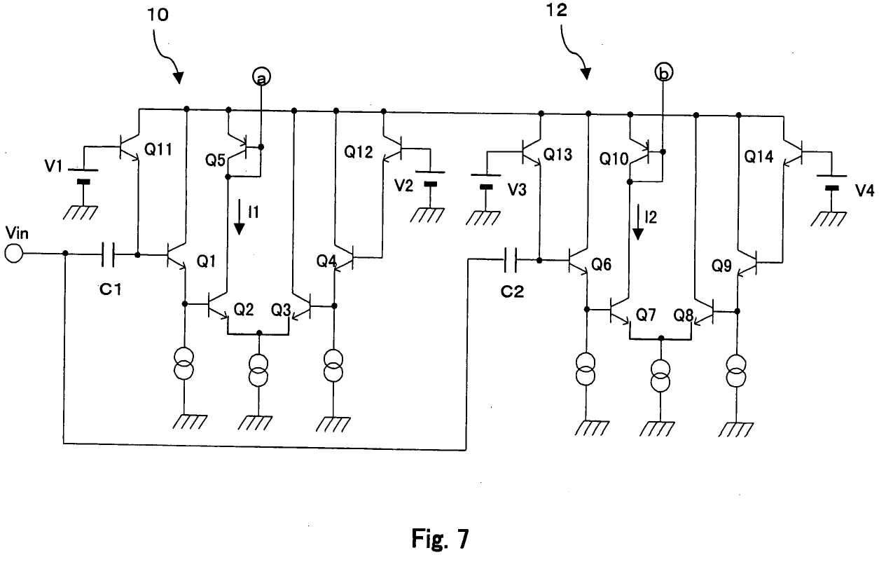

Next, FIG. 7 shows a specific configuration for the AGC detector circuit 10 and the no-signal detector circuit 12. As outputs, the AGC detector circuit 10 and the no-signal detector circuit 12 output currents I1 and I2. Since the objects of the judgments differ, the magnitudes of the reference voltages differ. However, the basic operations are identical and identical circuits are depicted in the drawing. Thus, the description hereinafter refers only to the AGC detector circuit 10.

The playback signal, which is the output of the AGC amplifier AP1, is supplied to input terminal Vin. This input signal passes a capacitor Cl and is input by the base of an NPN transistor Q1. To the base of the transistor Q1 is connected the emitter of an NPN transistor Q11, of which the collector is connected to the voltage supply V_{cc} and the base is supplied with a reference voltage V1, so that the base is basically offset (matches the lower terminal) by a voltage of 1V_{be} from the reference voltage V1 and becomes superimposed with AC components of the input signal.

The transistor Q1 has its collector connected to the voltage supply V_{cc} and its emitter connected to ground through a constant current source. The emitter of the transistor Q1 is connected to the base of an NPN transistor Q2. The emitter of the transistor Q2 is connected to ground through a constant current source and also to the emitter of an NPN transistor Q3. The collector of the transistor Q3 is connected to the voltage source V_{cc}. The base of the transistor Q3 is connected to ground through a constant current source and also to the emitter of an NPN transistor Q4. The collector of the transistor Q4 is connected to the voltage source V_{cc} and the base is connected to the emitter of an NPN transistor Q12, of which the collector is connected to the voltage source V_{cc} and the base is supplied with a reference voltage V2, so that the base of the transistor Q4 is fixed at a voltage of 1V_{be} lower than the reference voltage V2.

The collector of the transistor Q2 is connected to the collector of a PNP transistor Q5, of which the collector and base are shorted to each other and the emitter is connected to the voltage source V_{cc}. The base of the transistor Q5 becomes the output of current I1. Namely, providing a PNP transistor to configure a current mirror with the transistor Q5 allows the current I1 to be output.

This circuit forms a differential amplifier by mutually connecting the emitters of the transistors Q2 and Q3 to ground through the constant current source. The base potential of both transistors Q2 and Q3 are determined by the reference voltages V1 and V2. The current I1 in accordance with the input AC signal is obtained at the transistor Q5. Setting the potential difference of the reference voltages V1 and V2 enables the input signal level where the output current I1 begins to flow, namely, the AGC level, to be set.

Furthermore, the no-signal detector circuit 12 has an identical configuration and the current I2 in accordance with the input AC signal is obtained. The no-signal detector circuit 12 has a capacitor C2 corresponding to the capacitor C1, and transistors Q6-Q10 corresponding to the transistors Q1-Q5. Furthermore, the circuit has reference voltages V3 and V4 corresponding to the reference voltages V1 and V2, and transistors Q13 and Q14 corresponding to the transistors Q11 and Q12, the bases of which are supplied the reference voltages V3 and V4. The connections are also identical so that the overall circuit operates in an identical manner. Setting the potential difference of the reference voltages V3 and V4 enables the input signal level where the output current I2 begins to flow, namely, the no-signal criterion level, to be set. The potential difference of the voltages V3 and V4 is the no-signal detection level and is set to a value that is substantially smaller compared to the potential difference of the voltages V1 and V2.

The current I2 and the base of the transistor Q10 are connected to the base of the transistor Q40 depicted in the above-mentioned FIG. 5 (terminals b in the drawings are connected together). As a result, the current I2 flowing to the transistor Q10 indicating the presence of a signal also flows to the transistor Q40 so as to achieve the above-mentioned operation.

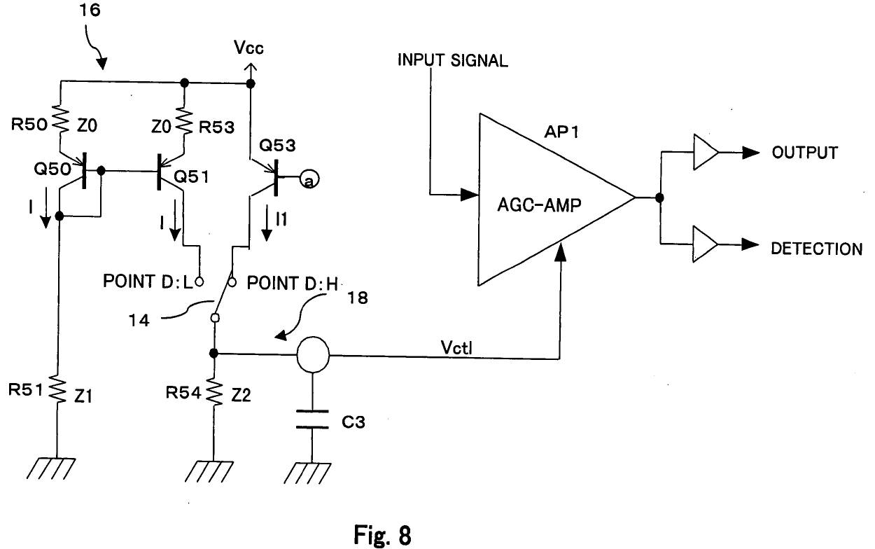

Furthermore, in FIG. 8 are shown the constant-current generator circuit 16, the switching circuit 14, the current-voltage converter circuit 18, and the AGC amplifier AP1.

First, the constant-current generator circuit 16 will be described. To the voltage source V_{cc} is connected the emitter of a PNP transistor Q50 through a resistor R50 having a resistance Z0. The transistor Q50 has its collector and base shorted to each other and the collector connected to ground through a resistor R51 having a resistance Z1. Therefore, a current of I=(V_{cc}−V_{be})/(Z0+Z1) flows to the transistor Q50.

To the base of the transistor Q50 is connected a transistor Q51, of which the emitter is connected to the voltage source V_{cc} through a resistor R53 having a resistance Z0 and the collector is connected to one input terminal of the switching circuit 14. Therefore, the transistor Q51 forms a current mirror with the transistor Q50 so that constant current I flows. The constant-current generator circuit 16 is configured in this manner and outputs constant current I.

Furthermore, to the other input terminal of the switching circuit 14 is connected a PNP transistor Q53 of which the emitter is connected to the voltage source V_{cc}. The base of the transistor Q53 is connected to the base of the transistor Q5 in the above-mentioned AGC detector circuit 10 (terminals a in the drawings are connected together) and forms a current mirror with the transistor Q5. Therefore, the to current I1 relating to the level of the playback signal flows the transistor Q53.

The switching circuit 14 selects, according to the output signal from the above-mentioned comparator 44, the current I1 from a constant current source CC50 when there is a signal present or the current I when there is no signal. Namely, current I1 is selected when the output (point D) of the comparator 44 in FIG. 5 is H and current I is selected when the output is L.

The output terminal of the switching circuit is connected to ground through a resistor R54 having a resistance Z2. Therefore, the current I or I1 is converted to a voltage by the resistor R54. Namely, the control voltage (detection voltage) becomes Vct1=Z2·I when there is no signal and Vct1=Z2·I1 when there is a signal present. Furthermore, the resistor R54 is connected to an external capacitor C3 of which the other end is connected to ground and which smoothes the control voltage Vct1.

The control voltage Vct1 is supplied to the AGC amplifier AP1 as a gain control signal to control the gain of the AGC amplifier AP1.

In this manner, according to the present embodiment, besides the AGC current obtained from the AGC detector circuit 10, the constant-current generator circuit 16 is provided. The constant-current generator circuit 16 fixes the control voltage by causing a fixed current to flow, such as in the period of transition from a small or no signal to the presence of a signal. In addition to achieving a faster AGC operation, this solves the problem of the AGC amplifier AP1 being at full gain when there is no signal and causing a degraded signal-to-noise ratio.

It should be noted that while the level of the output of the AGC amplifier AP1 was detected as the level of the playback signal in the above-mentioned embodiment, the level of the input signal may be detected instead.

As described hereinbefore, the gain of the AGC amplifier when there is no signal can be set to an appropriate value so as to prevent noise from being greatly amplified. Furthermore, since the control signal for when there is no signal has been set to an appropriate level, the AGC tracking characteristic can be improved for the transition from no signal to the presence of a signal.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. An AGC circuit for amplifying a playback signal at a gain according to the level thereof, comprising:
a level detector circuit for detecting the level of the playback signal;
an AGC signal generator circuit for generating an AGC signal according to the detected level;
a constant level signal generator circuit for generating a constant level signal at a predetermined level;
a switching circuit for selecting and outputting either the AGC signal or the constant level signal as a control signal;
an AGC amplifier for amplifying and outputting the playback signal at a gain on the basis of said control signal; and
a signal presence/absence judgment circuit for judging a no-signal state or a signal present state by whether or not the signal level of the playback signal is equal to or less than a predetermined level;
said switching circuit selects, according to the judgment result of said signal presence/absence judgment circuit, said AGC signal when there is a signal present or said constant level signal when there is no signal.

2. The circuit according to claim 1:
wherein said AGC signal and said constant current signal are current signals; and
further comprising a current-voltage converter circuit for converting said AGC signal or said constant current signal that is output from said switching circuit into a voltage signal;
the voltage signal that is output from the current-voltage converter circuit is supplied to said AGC amplifier as said control signal.

3. The circuit according to claim 1, wherein:
said signal presence/absence judgment circuit comprises an internal delay circuit, which changes the output signal with a delay of a predetermined time when the signal state changes from no signal to signal present or signal present to no signal.

4. The circuit according to claim 3, wherein said signal presence/absence judgment circuit comprises:
a first comparator circuit for comparing the level of the playback signal with a predetermined reference level;
a time constant circuit for integrating the output of the first comparator circuit with a predetermined time constant; and
a second comparator circuit for comparing the output of the time constant circuit with a predetermined reference level;
said time constant circuit functions as said delay circuit.

5. The circuit according to claim 1, wherein:
the gain of the AGC amplifier is 0 dB or lower in the case where said constant level signal was selected.
